(19) United States
(12) Patent Application Publication
(10) Pub. No.: US 2023/0421339 A1
(43) Pub. Date: Dec. 28, 2023

(54) INDICATIONS OF ACTIVITY STATUSES OF BEAMS FOR A FREQUENCY RESOURCE RANGE

(71) Applicant: QUALCOMM Incorporated, San Diego, CA (US)

(72) Inventors: Jigneshkumar SHAH, San Diego, CA (US); Abhishek Saurabh SACHIDANAND SINHA, San Diego, CA (US); Michael Francis GARYANTES, Bradley Beach, NJ (US); Deepak AGARWAL, San Diego, CA (US); Shmuel VAGNER, San Diego, CA (US)

(21) Appl. No.: 17/808,948

(22) Filed: Jun. 24, 2022

(51) Int. Cl. H04L 5/00; H04W 72/04

(52) U.S. Cl. CPC H04L 5/0096; H04W 72/046; H04W 72/0453

(57) ABSTRACT

Various aspects of the present disclosure generally relate to wireless communication. In some aspects, a first network node may provide, to a second network node, an indication of a configuration of a beam group type that supports indications of activity statuses of beams for a frequency resource range. The first network node may provide, to the second network node, an indication of the activity statuses of the beams for the frequency resource range, the indication of the activity statuses of the beams including an indication of a first set of beams that are active and an indication of a second set of beams that are inactive. Numerous other aspects are described.

### FIELD OF THE DISCLOSURE

Aspects of the present disclosure generally relate to wireless communication and to techniques and apparatuses for indications of activity statuses of beams for a frequency resource range.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first network node. The method may include providing, to a second network node, an indication of a configuration of a beam group type that supports indications of activity statuses of beams for a frequency resource range. The method may include providing, to the second network node, an indication of the activity statuses of the beams for the frequency resource range, the indication of the activity statuses of the beams including an indication of a first set of beams that are active and an indication of a second set of beams that are inactive.

Some aspects described herein relate to a method of wireless communication performed by a first network node. The method may include receiving, from a second network node, an indication of a configuration of a beam group type that supports indications of activity statuses of beams for a frequency resource range. The method may include receiving, from the second network node, an indication of the activity statuses of the beams for the frequency resource range, the indication of the activity statuses of the beams including an indication of a first set of beams that are active and an indication of a second set of beams that are inactive.

Some aspects described herein relate to a first network node for wireless communication. The first network node may include a memory and one or more processors coupled to the memory. The one or more processors may be configured to provide, to a second network node, an indication of a configuration of a beam group type that supports indications of activity statuses of beams for a frequency resource range. The one or more processors may be configured to provide, to the second network node, an indication of the activity statuses of the beams for the frequency resource range, the indication of the activity statuses of the beams including an indication of a first set of beams that are active and an indication of a second set of beams that are inactive.

Some aspects described herein relate to a first network node for wireless communication. The first network node may include a memory and one or more processors coupled to the memory. The one or more processors may be configured to receive, from a second network node, an indication of a configuration of a beam group type that supports indications of activity statuses of beams for a frequency resource range. The one or more processors may be configured to receive, from the second network node, an indication of the activity statuses of the beams for the frequency resource range, the indication of the activity statuses of the beams including an indication of a first set of beams that are active and an indication of a second set of beams that are inactive.

Some aspects described herein relate to a non-transitory computer-readable medium that stores a set of instructions for wireless communication by a first network node. The set of instructions, when executed by one or more processors of the first network node, may cause the first network node to provide, to a second network node, an indication of a configuration of a beam group type that supports indications of activity statuses of beams for a frequency resource range. The set of instructions, when executed by one or more processors of the first network node, may cause the first network node to provide, to the second network node, an indication of the activity statuses of the beams for the frequency resource range, the indication of the activity statuses of the beams including an indication of a first set of beams that are active and an indication of a second set of beams that are inactive.

Some aspects described herein relate to a non-transitory computer-readable medium that stores a set of instructions for wireless communication by a first network node. The set of instructions, when executed by one or more processors of the first network node, may cause the first network node to receive, from a second network node, an indication of a configuration of a beam group type that supports indications of activity statuses of beams for a frequency resource range. The set of instructions, when executed by one or more processors of the first network node, may cause the first network node to receive, from the second network node, an indication of the activity statuses of the beams for the frequency resource range, the indication of the activity statuses of the beams including an indication of a first set of beams that are active and an indication of a second set of beams that are inactive.

Some aspects described herein relate to an apparatus for wireless communication. The apparatus may include means for providing, to a second network node, an indication of a configuration of a beam group type that supports indications of activity statuses of beams for a frequency resource range. The apparatus may include means for providing, to the second network node, an indication of the activity statuses of the beams for the frequency resource range, the indication of the activity statuses of the beams including an indication of a first set of beams that are active and an indication of a second set of beams that are inactive.

Some aspects described herein relate to an apparatus for wireless communication. The apparatus may include means for receiving, from a second network node, an indication of a configuration of a beam group type that supports indications of activity statuses of beams for a frequency resource range. The apparatus may include means for receiving, from the second network node, an indication of the activity statuses of the beams for the frequency resource range, the indication of the activity statuses of the beams including an indication of a first set of beams that are active and an indication of a second set of beams that are inactive.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of antenna ports, in accordance with the present disclosure.

FIG. 5 is a diagram illustrating an example of allocation of frequency resources and spatial resources for communication streams, in accordance with the present disclosure.

FIG. 6 is a diagram illustrating an example of an allocation of frequency resources and spatial resources for communication streams, in accordance with the present disclosure.

FIG. 7 is a diagram of an example associated with indications of activity statuses of beams for a frequency resource range, in accordance with the present disclosure.

FIGS. 8A-8B are diagrams illustrating an example of an allocation of frequency resources and spatial resources for communication streams, in accordance with the present disclosure.

FIG. 9 is a diagram illustrating an example process performed, for example, by a first network node, in accordance with the present disclosure.

FIG. 10 is a diagram illustrating an example process performed, for example, by a first network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

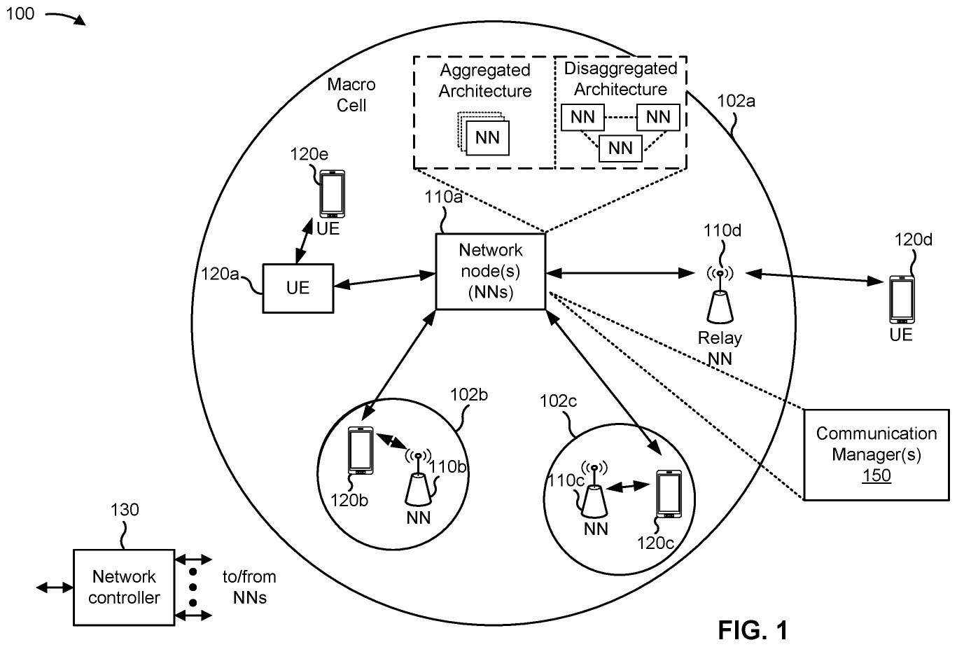

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the first network node may include a communication manager 150. As described in more detail elsewhere herein, the communication manager 150 may provide, to a second network node, an indication of a configuration of a beam group type that supports indications of activity statuses of beams for a frequency resource range; and provide, to the second network node, an indication of the activity statuses of the beams for the frequency resource range, the indication of the activity statuses of the beams including an indication of a first set of beams that are active and an indication of a second set of beams that are inactive. Additionally, or alternatively, the communication manager 150 may perform one or more other operations described herein.

In some aspects, the second network node may include a communication manager 150. As described in more detail elsewhere herein, the communication manager 150 may receive, from the first network node, an indication of a configuration of a beam group type that supports indications of activity statuses of beams for a frequency resource range; and receive, from the first network node, an indication of the activity statuses of the beams for the frequency resource range, the indication of the activity statuses of the beams including an indication of a first set of beams that are active and an indication of a second set of beams that are inactive. Additionally, or alternatively, the communication manager 150 may perform one or more other operations described herein.

As indicated above, FIG. 1 is provided as an example. Other examples may differ from what is described with regard to FIG. 1.

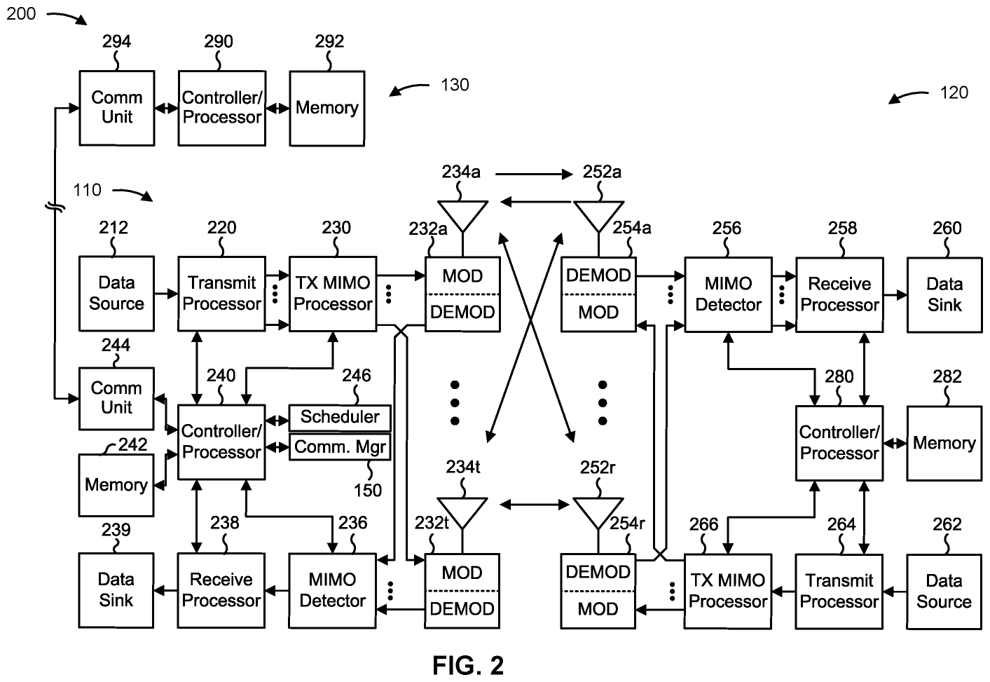

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

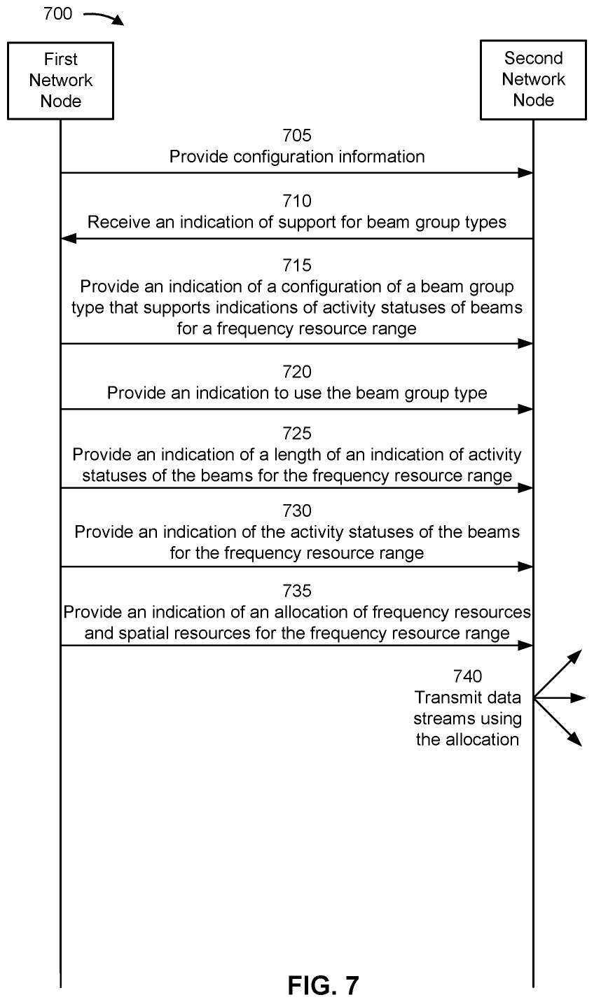

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

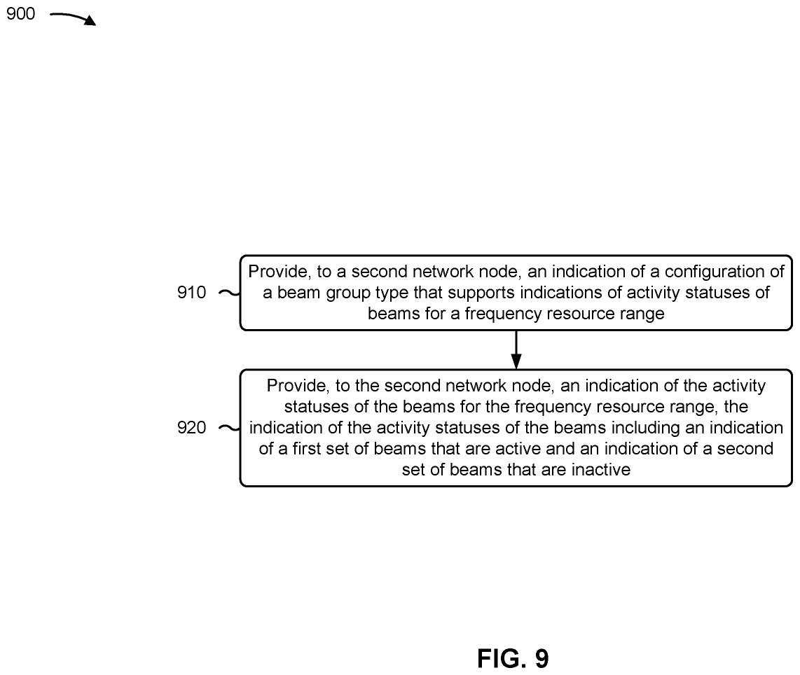

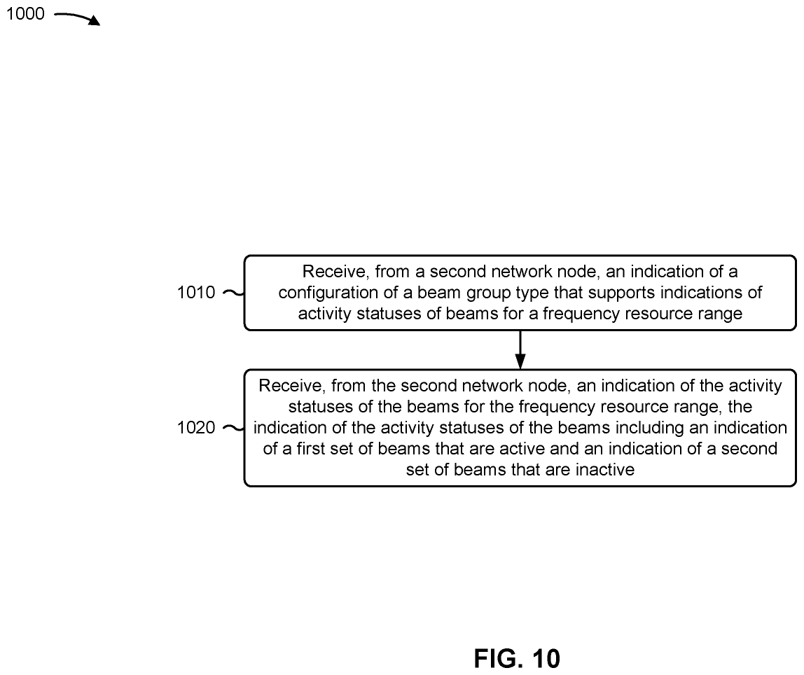

The controller/processor 240 of the network node 110, the controller/processor 280 of the UE 120, and/or any other component(s) of FIG. 2 may perform one or more techniques associated with indications of activity statuses of beams for a frequency resource range, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the first network node includes means for providing, to a second network node, an indication of a configuration of a beam group type that supports indications of activity statuses of beams for a frequency resource range; and/or means for providing, to the second network node, an indication of the activity statuses of the beams for the frequency resource range, the indication of the activity statuses of the beams including an indication of a first set of beams that are active and an indication of a second set of beams that are inactive. In some aspects, the means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the second network node includes means for receiving, from the first network node, an indication of a configuration of a beam group type that supports indications of activity statuses of beams for a frequency resource range; and/or means for receiving, from the first network node, an indication of the activity statuses of the beams for the frequency resource range, the indication of the activity statuses of the beams including an indication of a first set of beams that are active and an indication of a second set of beams that are inactive. In some aspects, the means for the second network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

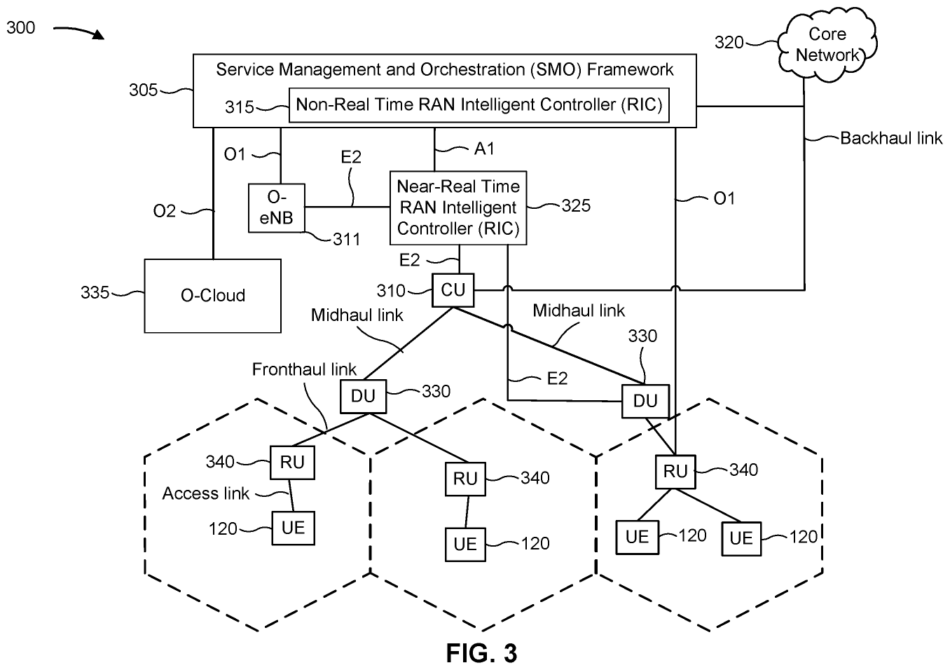

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 335) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

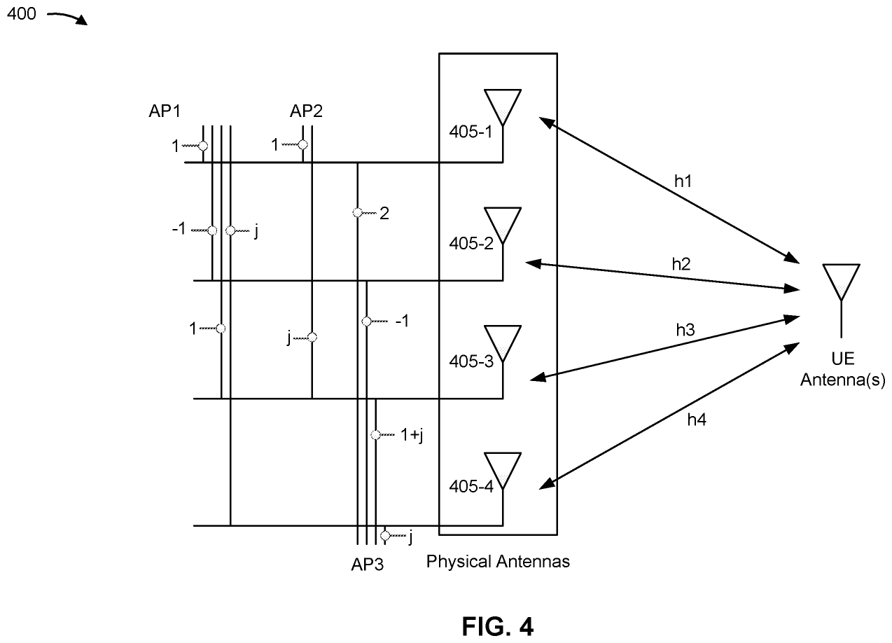

FIG. 4 is a diagram illustrating an example 400 of antenna ports, in accordance with the present disclosure.

As shown in FIG. 4, a first physical antenna 405-1 of a network node (e.g., an RU) may communicate (e.g., transmit and/or receive) information via a first channel h1, a second physical antenna 405-2 may communicate information via a second channel h2, a third physical antenna 405-3 may communicate information via a third channel h3, and a fourth physical antenna 405-4 may communicate information via a fourth channel h4. Such information may be conveyed via a logical antenna port, which may represent some combination of the physical antennas and/or channels. In some cases, one or more UEs communicating with the network node may not have knowledge of the channels associated with the physical antennas, and may only operate based on knowledge of the channels associated with antenna ports, as defined below.

An antenna port may be defined such that a channel, over which a symbol on the antenna port is conveyed, can be inferred from a channel over which another symbol on the same antenna port is conveyed. In example 400, a channel associated with antenna port 1 (AP1) is represented as h1−h2+h3+j*h4, where channel coefficients (e.g., 1, −1, 1, and j, in this case) represent weighting factors (e.g., indicating phase and/or gain) applied to each channel. Such weighting factors may be applied to the channels to improve signal power and/or signal quality at one or more receivers. Applying such weighting factors to channel transmissions may be referred to as precoding, and a precoder may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+(1+j)*h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j)*h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

In some networks, antenna ports may be associated with extended antenna carrier identifiers (eAxC-IDs). The antenna ports and/or the eAxC-IDs may be associated with a data stream and/or communication link for communicating with an additional device (e.g., a UE) and/or a layer (e.g., a spatial layer) of the data stream and/or the communication link. The antenna ports and/or physical antennas may be included in an RU that is associated with an additional network node, such as a DU and/or a CU. The additional node may provide, to the RU, an allocation of frequency resources and spatial resources for communicating with one or more UEs. For example, the additional node may indicate an antenna port and/or beam to use for a set of frequency resources (e.g., resources blocks (RBs)) when communicating with a UE.

As indicated above, FIG. 4 is provided merely as an example. Other examples may differ from what is described with regard to FIG. 4.

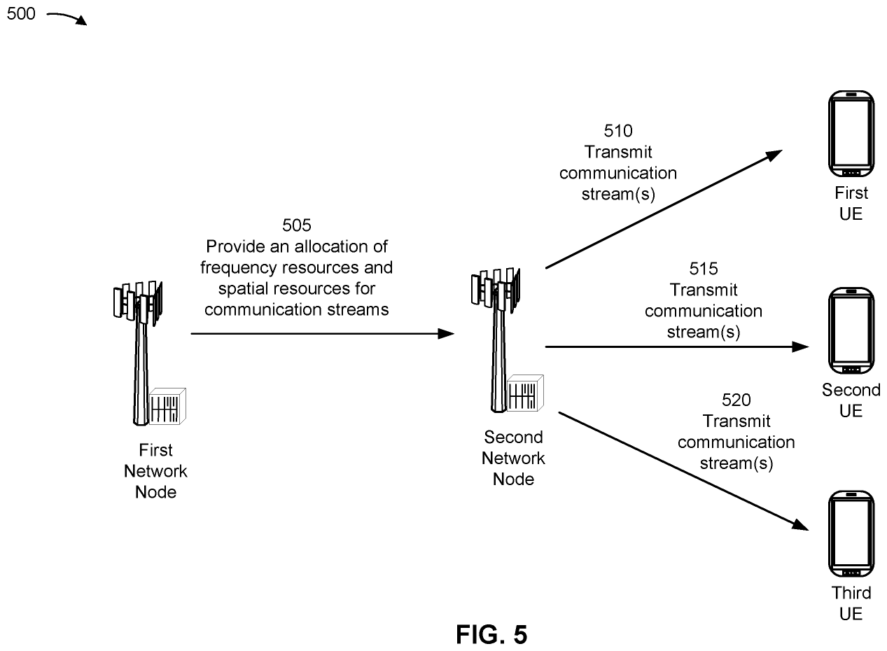

FIG. 5 is a diagram illustrating an example 500 of allocation of frequency resources and spatial resources for communication streams, in accordance with the present disclosure.

As shown in FIG. 5, and by reference number 505, a first network node (e.g., an RU and/or DU) may provide to a second network node (e.g., an RU) an allocation of frequency resources and spatial resources for communication streams. The first network node may provide the allocation using a section extension (SE) message, such as an SE 10 message. The SE message may indicate a beam vector listing with a restriction to using with layer continuity. For example, eAxC-ID values in a member list (e.g., member-[tr]x-eaxc-id) list in a management plane (e.g., M-Plane and/or RAN management plane, among other examples) are expected to be consecutive values. Associated port beam identifications in the SE (e.g., SE=10) are also expected to be consecutive (assuming a single member-list is configured in the management plane). If non-consecutive beams are to be allocated, the first network node may provide multiple SE messages to the second network node.

As shown by reference number 510, the second network node may transmit one or more communication streams to a first UE using a first set of frequency resources and spatial resources (e.g., one or more beams). As shown by reference number 515, the second network node may transmit one or more communication streams to a second UE using a second set of frequency resources and spatial resources (e.g., one or more beams). As shown by reference number 520, the second network node may transmit one or more communication streams to a third UE using a third set of frequency resources and spatial resources (e.g., one or more beams).

As indicated above, FIG. 5 is provided merely as an example. Other examples may differ from what is described with regard to FIG. 5.

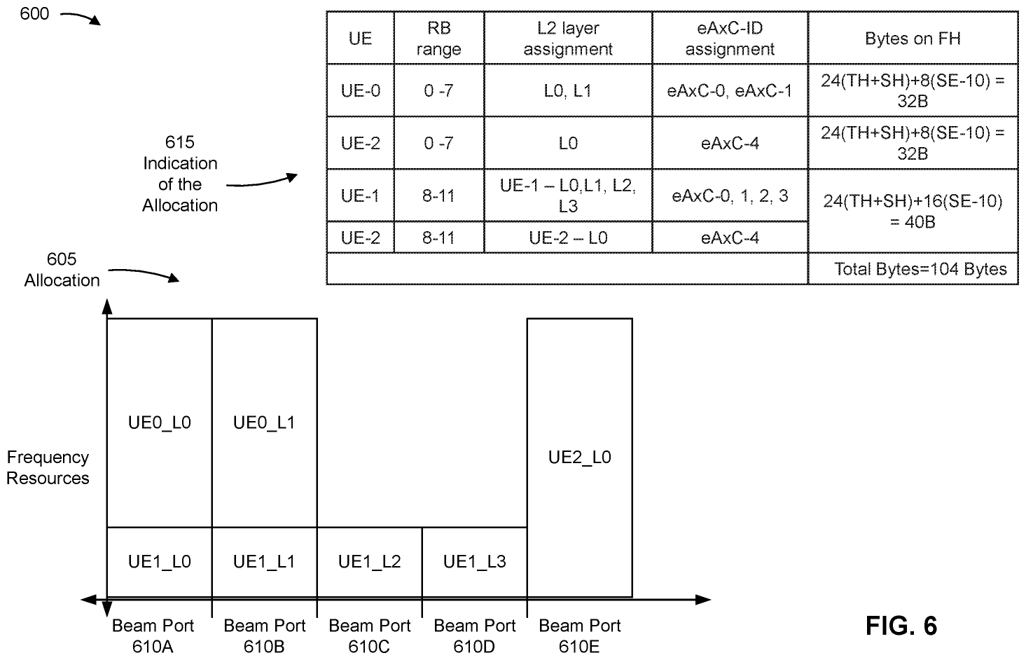

FIG. 6 is a diagram illustrating an example 600 of an allocation of frequency resources and spatial resources for communication streams, in accordance with the present disclosure.

As shown in FIG. 6, and by reference number 605, an allocation of resources may include a set of frequency resources associated with a beam port 610A, beam port 610B, beam port 610C, beam port 610D, and beam port 610E. A number of beam ports is configurable and is not limited to 5 as shown in FIG. 6.

As shown in FIG. 6, a first allocation to a spatial layer 0 (L0) of a UE0 includes a first subset of the set of frequency resources for transmission via the beam port 610A. A second allocation to a spatial layer 0 of a UE1 includes a second subset of the set of frequency resources for transmission via the beam port 610A.

A third allocation to a spatial layer 1 (L1) of the UE0 includes a first subset of the set of frequency resources for transmission via the beam port 610B. A fourth allocation to a spatial layer 1 of the UE1 includes a second subset of the set of frequency resources for transmission via the beam port 610B.

A fifth allocation to a spatial layer 2 (L2) of the UE1 includes a first subset of the set of frequency resources for transmission via the beam port 610C. However, a second subset of the frequency resources of the beam port 610C are not allocated. This is a gap in the allocation. Similarly, a sixth allocation to a spatial layer 3 (L3) of the UE1 includes a first subset of the set of frequency resources for transmission via the beam port 610D. Again, a second subset of the frequency resources of the beam port 610D are not allocated. This is an additional gap in the allocation.

A seventh allocation to a spatial layer 0 of a UE2 includes the set of frequency resources for transmission via the beam port 610E.

As shown by reference number 615, an indication of the allocation may include indications of a UE, a frequency resource range (e.g., RB range), a layer 2 assignment of spatial layer for the UE, and/or a beam assignment (e.g., an eAxC-ID assignment, and/or a port assignment, among other examples) for each allocation. As shown, indications of the first allocation and the third allocation can be combined into a 32 byte first indication and an indication of a first subset of the seventh allocation is provided in a 32 byte second indication. The first indication and the second indication may be separately indicated based at least in part on a section description specifying RBs 0-7 not supporting SE=10 because the eAxC-IDs assigned by L2 are not consecutive. Instead, multiple separate section descriptions are required for UE0_L0, UE0_L1 and UE2_L0 allocations due to this restriction.

The second allocation, the fourth allocation, the fifth allocation, the sixth allocation, and the second subset of the seventh allocation can be combined into a 40 byte third indication. In total, the indication of the allocation may include 104 bytes to provide the indications.

Based at least in part on the first indication and the second indication using different indications, the indication of the allocation may consume an amount of overhead that is greater than a combined indication. This overhead may negatively affect a front haul (e.g., DU-to-RU) load, which may affect selection of load divisions and efficiency of the front haul.

As indicated above, FIG. 6 is provided merely as an example. Other examples may differ from what is described with regard to FIG. 6.

In some aspects described herein, a first network node may provide an indication of activity statuses of beams for a frequency resource range. The indication of the activity statuses may support an indication of an allocation of frequency resources and spatial resources with a gap in a way that reduces, relative to an allocation indication that does not support non-contiguous spatial resources, a number of bits (bytes) needed to indicate the allocation. In this way, the first network node may conserve an amount of overhead used for the indication of the allocation to a second network node (e.g., an RU). This overhead may reduce congestion on a front haul (e.g., DU-to-RU), which may improve selection of load divisions and efficiency of the front haul.

FIG. 7 is a diagram of an example 700 associated with indications of activity statuses of beams for a frequency resource range, in accordance with the present disclosure. As shown in FIG. 7, a first network node (e.g., network node 110, a CU, or a DU) may communicate with a second network node (e.g., network node 110 or an RU). In some aspects, the first network node and the second network node may be part of a wireless network (e.g., wireless network 100). The first network node and the second network node may be configured to provide a RAN for communication between a core network and one or more UEs and/or additional wireless devices. The first network node and the second network node may have established a wireless connection prior to operations shown in FIG. 7.

As shown by reference number 705, the first network node may transmit, and the second network node may receive, configuration information. In some aspects, the first network node may provide the configuration information during a device setup or a device reconfiguration of the second network node.

In some aspects, the configuration information may indicate that the second network node is to provide a communication link (e.g., a physical layer of the communication link) for one or more UEs or other wireless devices based at least in part on configuration signaling, control signaling, and/or allocation signaling from the first network node and/or an additional network node (e.g., a CU and/or a core network node, among other examples).

The second network node may configure itself based at least in part on the configuration information. In some aspects, the second network node may be configured to perform one or more operations described herein based at least in part on the configuration information.

As shown by reference number 710, the second network node may provide, and the first network node may receive, an indication of support for beam group types. In some aspects, the second network node may indicate support for a beam group type (e.g., beam group type 11) that supports indications of activity statuses of beams for a frequency resource range and/or non-contiguous spatial resources (e.g., having a gap in frequency resources and spatial resources).

As shown by reference number 715, the second network node may receive, and the first network node may provide, an indication of a configuration of a beam group type that supports indications of activity statuses of beams for a frequency resource range. In some aspects, the indication of the configuration may indicate a format of a message (e.g., an SE message) that indicates activity statuses of beams and non-contiguous spatial resources for a set of frequency resources. In some aspects, the first network node may provide an indication of configurations of one or more additional beam group types.

As shown by reference number 720, the second network node may receive, and the first network node may provide, an indication to use the beam group type that supports indications of activity statuses of beams and non-contiguous spatial resources for the set of frequency resources. For example, the first network node may provide an indication that an indication of the activity statuses is associated with the beam group type. In some aspects, the indication to use the beam group type may be included in a same message (e.g., an SE message) that indicates the activity statuses and/or an allocation of frequency resources and spatial resources.

As shown by reference number 725, the second network node may receive, and the first network node may provide, an indication of a length of an indication of activity statuses of the beams for the frequency resource range. In some aspects, the indication of the length may include an indication (e.g., a 4-bit indication) in a field of an indication of an allocation of frequency resources and spatial resources. The indication of the length may include a parameter that specifies a length of a port mask (portMask) that indicates the activity statuses of the beams.

As shown by reference number 730, the second network node may receive, and the first network node may provide, an indication of the activity statuses of the beams for the frequency resource range. In some aspects, the indication of the activity statuses of the beams may include an indication of a first set of beams that are active and an indication of a second set of beams that are inactive for the frequency range or a subset of the frequency range. The indication of the activity statuses of the beams may include a bitmap. The bits of the bitmap may be associated with different beams, streams, and/or eAxCs. For example, a first bit may indicate activity status of a first beam, stream and/or eAxC, a second bit may indicate activity status of a second beam, stream and/or eAxC, and so on.

In some aspects, the indication of the activity status may include a bitmask. The bitmask (e.g., a portMask) may have a length equal to a size of a member list of beams and/or antenna ports (e.g., member-eaxcid-list). In some aspects, bits set to ‘1’ in the bitmask may indicate presence and/or activity of a corresponding antenna port from the member list. In some aspects, bits set to ‘0’ in the bitmask may indicate an absence or inactivity of the corresponding port from the member list. In some aspects, the bitmask may be associated with an additional indication (e.g., numPortc) of a number of bits set to ‘1’ in the bitmask.

As shown by reference number 735, the second network node may receive, and the first network node may provide, an indication of an allocation of frequency resources and spatial resources for the frequency resource range. In some aspects, the allocation may have a gap in which no data stream is allocated to a resource at a frequency resource using a spatial resource.

In some aspects, spatial resources of the allocation are associated with different beams. In some aspects, one or more first beams of the different beams are associated with a first UE and one or more second beams of the different beams are associated with a second UE.

In some aspects, the indication of the allocation of frequency resources and spatial resources for the frequency resource range is based at least in part on the activity statuses of the beams. For examples, the allocation of the frequency resources and the spatial resources for the frequency range may include allocated resources and a gap where no beams, antenna ports, and/or eAxC-IDs are active for the frequency range or a subset of the frequency range.

In some aspects, the configuration of the beam group type that supports indications of activity statuses may support indicating the allocation using a reduced number of bits (e.g., bytes) when compared to an indication of the allocation using a beam group type that does not support the indications of the activity status. For example, the beam group type may be associated with a first number of bits to indicate an allocation of frequency resources and spatial resources for the frequency resource range and an additional configuration of an additional beam group type is associated with a second number of bits to indicate the allocation of frequency resources and the spatial resources for the frequency resource range. The first number of bits may be less than the second number of bits based at least in part on the spatial resources being non-contiguous spatial resources (e.g., the allocation including a gap). In some aspects, the configuration of the beam group type may be associated with using a single message to indicate an allocation of non-contiguous spatial resources for a subset of the frequency resource range. In some aspects, the configuration of the beam group type may be associated with using a single message having a reduced number of section descriptions to indicate an allocation of non-contiguous spatial resources for a subset of the frequency resource range.

In some aspects, the indications described in connection with reference numbers 720, 725, and/or 730 may be provided in a single message (e.g., an SE message) or in multiple messages.

As shown by reference number 740, the second network node may transmit data streams using the allocation of the frequency resources and spatial resources for the frequency resource range. In some aspects, the second network node may transmit multiple streams, using multiple spatial resources, to a single UE.

Based at least in part on the first network node using the beam group type that supports indications of activity statuses of beams and/or non-contiguous spatial resources, the first network node may conserve an amount of overhead used for the indication of the allocation to a second network node (e.g., an RU). This overhead may reduce congestion on a front haul (e.g., DU-to-RU), which may improve selection of load divisions and efficiency of the front haul.

As indicated above, FIG. 7 is provided as an example. Other examples may differ from what is described with respect to FIG. 7.

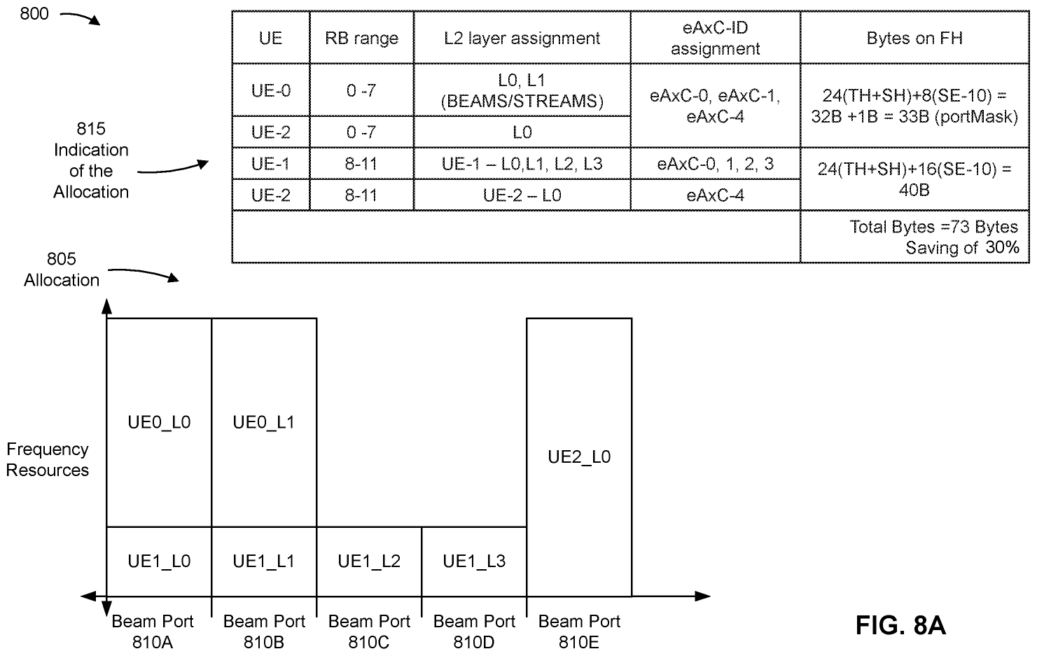

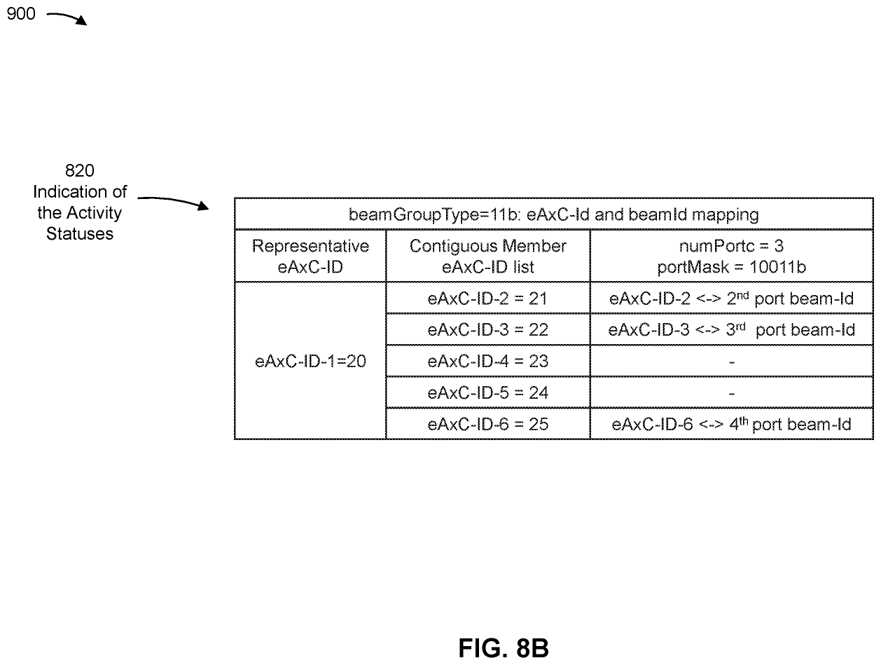

FIGS. 8A-8B are diagrams illustrating an example 800 of an allocation of frequency resources and spatial resources for communication streams, in accordance with the present disclosure.

As shown in FIG. 8A, and by reference number 805, an allocation of resources may include a set of frequency resources associated with a beam port 810A, beam port 810B, beam port 810C, beam port 810D, and beam port 810E. A number of beam ports is configurable and is not limited to 5 as shown in FIG. 8A.

As shown in FIG. 8A, a first allocation to a spatial layer 0 (L0) of a UE0 includes a first subset of the set of frequency resources for transmission via the beam port 810A. A second allocation to a spatial layer 0 of a UE1 includes a second subset of the set of frequency resources for transmission via the beam port 810A.

A third allocation to a spatial layer 1 (L1) of the UE0 includes a first subset of the set of frequency resources for transmission via the beam port 810B. A fourth allocation to a spatial layer 1 of the UE1 includes a second subset of the set of frequency resources for transmission via the beam port 810B.

A fifth allocation to a spatial layer 2 (L2) of the UE1 includes a first subset of the set of frequency resources for transmission via the beam port 810C. However, a second subset of the frequency resources of the beam port 810C are not allocated. This is a gap in the allocation. Similarly, a sixth allocation to a spatial layer 3 (L3) of the UE1 includes a first subset of the set of frequency resources for transmission via the beam port 810D. Again, a second subset of the frequency resources of the beam port 810D are not allocated. This is an additional gap in the allocation.

A seventh allocation to a spatial layer 0 of a UE2 includes the set of frequency resources for transmission via the beam port 810E.

As shown by reference number 815, an indication of the allocation may include indications of a UE, a frequency resource range (e.g., RB range), a layer 2 assignment of spatial layer for the UE, and/or a beam assignment (e.g., an eAxC-ID assignment, and/or a port assignment, among other examples) for each allocation. As shown, indications of the first allocation, the third allocation, and a first subset of the seventh allocation can be combined into a 33 byte first indication. For example, a byte may be added to provide a bitmask that indicates that the beam ports 810C and 810D are inactive and/or that the beam ports 810A, 810B, and 810E are active. The indications may be combined based at least in part on a section description specifying RBs 0-7 supporting SE=10 because the eAxC-IDs are able to be indicated as active or inactive. This may remove a need for multiple separate section descriptions for UE0_L0, UE0_L1 and UE2_L0 allocations.

The second allocation, the fourth allocation, the fifth allocation, the sixth allocation, and the second subset of the seventh allocation can be combined into a 40 byte third indication. In total, the indication of the allocation may include 73 bytes to provide the indications. This may reduce a number of bytes required for the indication of the allocation by 30% compared to an indication shown in FIG. 6.

As shown in FIG. 8B, and by reference number 820, the indication of the allocation may indicate a bitmap (bitmask). The bitmask may be configured with a representative eAxC-ID, beam port, and/or beam (shown as eAxC-ID-1=20). The bitmask may indicate activity of associated (e.g., numerically subsequent) eAxC-IDs, beam ports, and/or beams using a port mask. For example, the indication of the allocation may indicate activity statuses for 5 eAxC-IDs, beam ports, and/or beams that numerically follow the representative eAxC-ID, beam port, and/or beam. As shown in FIG. 8B, the bitmask (e.g., “portMask) may use a bitmask of 10011 (e.g., 10011b) to indicate that a fifth, second, and first eAxC-ID, beam port, and/or beam are active and/or that a fourth and a third eAxC-ID, beam port, and/or beam are inactive. In some aspects, the indication of the allocation may further indicate a number of active ports (e.g., numPortc=3).

As indicated above, FIGS. 8A and 8B are provided merely as an example. Other examples may differ from what is described with regard to FIGS. 8A and 8B.

FIG. 9 is a diagram illustrating an example process 900 performed, for example, by a first network node, in accordance with the present disclosure. Example process 900 is an example where the first network node (e.g., network node 110) performs operations associated with indications of activity statuses of beams for a frequency resource range.

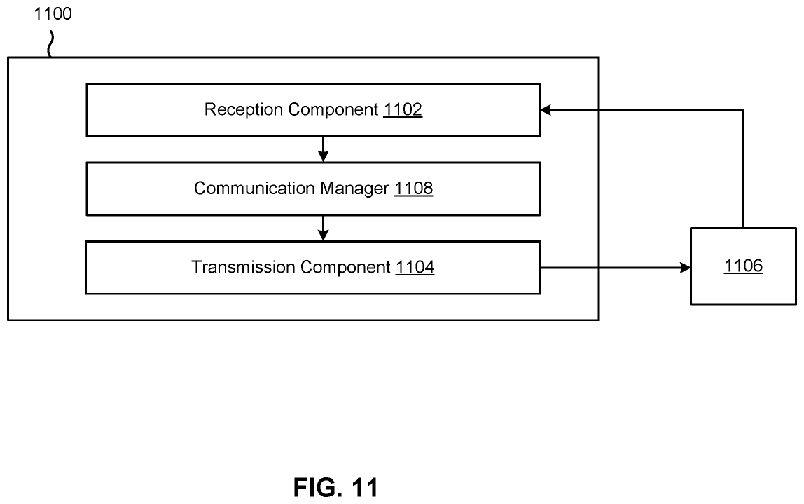

As shown in FIG. 9, in some aspects, process 900 may include providing, to a second network node, an indication of a configuration of a beam group type that supports indications of activity statuses of beams for a frequency resource range (block 910). For example, the first network node (e.g., using communication manager 150 and/or transmission component 1104, depicted in FIG. 11) may provide, to a second network node, an indication of a configuration of a beam group type that supports indications of activity statuses of beams for a frequency resource range, as described above.

As further shown in FIG. 9, in some aspects, process 900 may include providing, to the second network node, an indication of the activity statuses of the beams for the frequency resource range, the indication of the activity statuses of the beams including an indication of a first set of beams that are active and an indication of a second set of beams that are inactive (block 920). For example, the first network node (e.g., using communication manager 150 and/or transmission component 1104, depicted in FIG. 11) may provide, to the second network node, an indication of the activity statuses of the beams for the frequency resource range, the indication of the activity statuses of the beams including an indication of a first set of beams that are active and an indication of a second set of beams that are inactive, as described above.

Process 900 may include additional aspects, such as any single aspect or any combination of aspects described below and/or in connection with one or more other processes described elsewhere herein.

In a first aspect, the first network node comprises a distributed unit, and wherein the second network node comprises a radio unit.

In a second aspect, alone or in combination with the first aspect, one or more first beams of the beams are associated with a first UE, and wherein one or more second beams of the beams are associated with a second UE.

In a third aspect, alone or in combination with one or more of the first and second aspects, the indication of the activity statuses comprises a bitmap, and wherein bits of the bitmap indicate activity statuses of the beams of the frequency resource range.

In a fourth aspect, alone or in combination with one or more of the first through third aspects, process 900 includes providing an indication of a length of the indication of the activity statuses of the beams for the frequency resource range.

In a fifth aspect, alone or in combination with one or more of the first through fourth aspects, process 900 includes providing an indication that the indication of the activity statuses is associated with the beam group type.

In a sixth aspect, alone or in combination with one or more of the first through fifth aspects, process 900 includes providing an indication of an allocation of frequency resources and spatial resources for the frequency resource range, wherein the allocation of the frequency resources and spatial resources of for the frequency resource range is based at least in part on the activity statuses of the beams.

In a seventh aspect, alone or in combination with one or more of the first through sixth aspects, process 900 includes receiving an indication that the second network node supports the configuration of the beam group type.

In an eighth aspect, alone or in combination with one or more of the first through seventh aspects, the configuration of the beam group type is associated with a first number of bits to indicate an allocation of frequency resources and spatial resources for the frequency resource range, wherein an additional configuration of an additional beam group type is associated with a second number of bits to indicate the allocation of frequency resources and the spatial resources for the frequency resource range, and wherein the first number of bits is less than the second number of bits based at least in part on the spatial resources being non-contiguous spatial resources.

In a ninth aspect, alone or in combination with one or more of the first through eighth aspects, the configuration of the beam group type is associated with using a single message to indicate an allocation of non-contiguous spatial resources for a subset of the frequency resource range.

In a tenth aspect, alone or in combination with one or more of the first through ninth aspects, providing the indication of the activity statuses of the beams for the frequency resource range comprises providing a section extension message.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first network node, in accordance with the present disclosure. Example process 1000 is an example where the first network node (e.g., network node 110) performs operations associated with indications of activity statuses of beams for a frequency resource range.

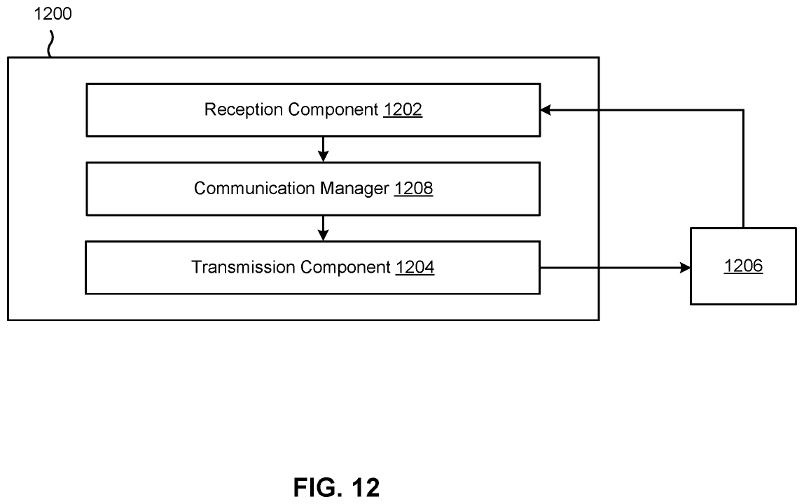

As shown in FIG. 10, in some aspects, process 1000 may include receiving, from a second network node, an indication of a configuration of a beam group type that supports indications of activity statuses of beams for a frequency resource range (block 1010). For example, the first network node (e.g., using communication manager 150 and/or reception component 1202, depicted in FIG. 12) may receive, from a second network node, an indication of a configuration of a beam group type that supports indications of activity statuses of beams for a frequency resource range, as described above.

As further shown in FIG. 10, in some aspects, process 1000 may include receiving, from the second network node, an indication of the activity statuses of the beams for the frequency resource range, the indication of the activity statuses of the beams including an indication of a first set of beams that are active and an indication of a second set of beams that are inactive (block 1020). For example, the first network node (e.g., using communication manager 150 and/or reception component 1202, depicted in FIG. 12) may receive, from the second network node, an indication of the activity statuses of the beams for the frequency resource range, the indication of the activity statuses of the beams including an indication of a first set of beams that are active and an indication of a second set of beams that are inactive, as described above.

Process 1000 may include additional aspects, such as any single aspect or any combination of aspects described below and/or in connection with one or more other processes described elsewhere herein.

In a first aspect, the second network node comprises a distributed unit, and wherein the first network node comprises a radio unit.

In a second aspect, alone or in combination with the first aspect, one or more first beams of the beams are associated with a first UE, and wherein one or more second beams of the beams are associated with a second UE.

In a third aspect, alone or in combination with one or more of the first and second aspects, the indication of the activity statuses comprises a bitmap, and wherein bits of the bitmap indicate activity statuses of the beams of the frequency resource range.

In a fourth aspect, alone or in combination with one or more of the first through third aspects, process 1000 includes receiving an indication of a length of the indication of the activity statuses of the beams for the frequency resource range.

In a fifth aspect, alone or in combination with one or more of the first through fourth aspects, process 1000 includes receiving an indication that the indication of the activity statuses is associated with the beam group type.

In a sixth aspect, alone or in combination with one or more of the first through fifth aspects, process 1000 includes receiving an indication of an allocation of frequency resources and spatial resources for the frequency resource range, wherein the allocation of the frequency resources and spatial resources of for the frequency resource range is based at least in part on the activity statuses of the beams.

In a seventh aspect, alone or in combination with one or more of the first through sixth aspects, process 1000 includes providing an indication that the first network node supports the configuration of the beam group type.

In an eighth aspect, alone or in combination with one or more of the first through seventh aspects, the configuration of the beam group type is associated with a first number of bits to indicate an allocation of frequency resources and spatial resources for the frequency resource range, wherein an additional configuration of an additional beam group type is associated with a second number of bits to indicate the allocation of frequency resources and the spatial resources for the frequency resource range, and wherein the first number of bits is less than the second number of bits based at least in part on the spatial resources being non-contiguous spatial resources.

In a ninth aspect, alone or in combination with one or more of the first through eighth aspects, the configuration of the beam group type is associated with using a single message to indicate an allocation of non-contiguous spatial resources for a subset of the frequency resource range.

In a tenth aspect, alone or in combination with one or more of the first through ninth aspects, receiving the indication of the activity statuses of the beams for the frequency resource range comprises receiving a section extension message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a first network node, or a first network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108 (e.g., the communication manager 150).

In some aspects, the apparatus 1100 may be configured to perform one or more operations described herein in connection with FIGS. 7-8B. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the first network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the first network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the first network node described in connection with FIG. 2. In some aspects, the transmission component 1104 may be co-located with the reception component 1102 in a transceiver.

The transmission component 1104 may provide, to a second network node, an indication of a configuration of a beam group type that supports indications of activity statuses of beams for a frequency resource range. The transmission component 1104 may provide, to the second network node, an indication of the activity statuses of the beams for the frequency resource range, the indication of the activity statuses of the beams including an indication of a first set of beams that are active and an indication of a second set of beams that are inactive.

The transmission component 1104 may provide an indication of a length of the indication of the activity statuses of the beams for the frequency resource range.

The transmission component 1104 may provide an indication that the indication of the activity statuses is associated with the beam group type.

The transmission component 1104 may provide an indication of an allocation of frequency resources and spatial resources for the frequency resource range wherein the allocation of the frequency resources and spatial resources of for the frequency resource range is based at least in part on the activity statuses of the beams.

The reception component 1102 may receive an indication that the second network node supports the configuration of the beam group type.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a first network node, or a first network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager 1208 (e.g., the communication manager 150).

In some aspects, the apparatus 1200 may be configured to perform one or more operations described herein in connection with FIGS. 7-8b. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the first network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the first network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the first network node described in connection with FIG. 2. In some aspects, the transmission component 1204 may be co-located with the reception component 1202 in a transceiver.

The reception component 1202 may receive, from a second network node, an indication of a configuration of a beam group type that supports indications of activity statuses of beams for a frequency resource range. The reception component 1202 may receive, from the second network node, an indication of the activity statuses of the beams for the frequency resource range, the indication of the activity statuses of the beams including an indication of a first set of beams that are active and an indication of a second set of beams that are inactive.

The reception component 1202 may receive an indication of a length of the indication of the activity statuses of the beams for the frequency resource range.

The reception component 1202 may receive an indication that the indication of the activity statuses is associated with the beam group type.

The reception component 1202 may receive an indication of an allocation of frequency resources and spatial resources for the frequency resource range wherein the allocation of the frequency resources and spatial resources of for the frequency resource range is based at least in part on the activity statuses of the beams.

The transmission component 1204 may provide an indication that the first network node supports the configuration of the beam group type.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first network node, comprising: providing, to a second network node, an indication of a configuration of a beam group type that supports indications of activity statuses of beams for a frequency resource range; and providing, to the second network node, an indication of the activity statuses of the beams for the frequency resource range, the indication of the activity statuses of the beams including an indication of a first set of beams that are active and an indication of a second set of beams that are inactive.

Aspect 2: The method of Aspect 1, wherein the first network node comprises a distributed unit, and wherein the second network node comprises a radio unit.

Aspect 3: The method of any of Aspects 1-2, wherein one or more first beams of the beams are associated with a first user equipment (UE), and wherein one or more second beams of the beams are associated with a second UE.

Aspect 4: The method of any of Aspects 1-3, wherein the indication of the activity statuses comprises a bitmap, and wherein bits of the bitmap indicate activity statuses of the beams of the frequency resource range.

Aspect 5: The method of any of Aspects 1-4, further comprising: providing an indication of a length of the indication of the activity statuses of the beams for the frequency resource range.

Aspect 6: The method of any of Aspects 1-5, further comprising: providing an indication that the indication of the activity statuses is associated with the beam group type.

Aspect 7: The method of any of Aspects 1-6, further comprising: providing an indication of an allocation of frequency resources and spatial resources for the frequency resource range, wherein the allocation of the frequency resources and spatial resources of for the frequency resource range is based at least in part on the activity statuses of the beams.

Aspect 8: The method of any of Aspects 1-7, further comprising: receiving an indication that the second network node supports the configuration of the beam group type.

Aspect 9: The method of any of Aspects 1-8, wherein the configuration of the beam group type is associated with a first number of bits to indicate an allocation of frequency resources and spatial resources for the frequency resource range, wherein an additional configuration of an additional beam group type is associated with a second number of bits to indicate the allocation of frequency resources and the spatial resources for the frequency resource range, and wherein the first number of bits is less than the second number of bits based at least in part on the spatial resources being non-contiguous spatial resources.

Aspect 10: The method of any of Aspects 1-9, wherein the configuration of the beam group type is associated with using a single message to indicate an allocation of non-contiguous spatial resources for a subset of the frequency resource range.

Aspect 11: The method of any of Aspects 1-10, wherein providing the indication of the activity statuses of the beams for the frequency resource range comprises: providing a section extension message.

Aspect 12: A method of wireless communication performed by a first network node, comprising: receiving, from a second network node, an indication of a configuration of a beam group type that supports indications of activity statuses of beams for a frequency resource range; and receiving, from the second network node, an indication of the activity statuses of the beams for the frequency resource range, the indication of the activity statuses of the beams including an indication of a first set of beams that are active and an indication of a second set of beams that are inactive.

Aspect 13: The method of Aspect 12, wherein the second network node comprises a distributed unit, and wherein the first network node comprises a radio unit.

Aspect 14: The method of any of Aspects 12-13, wherein one or more first beams of the beams are associated with a first user equipment (UE), and wherein one or more second beams of the beams are associated with a second UE.

Aspect 15: The method of any of Aspects 12-14, wherein the indication of the activity statuses comprises a bitmap, and wherein bits of the bitmap indicate activity statuses of the beams of the frequency resource range.

Aspect 16: The method of any of Aspects 12-15, further comprising: receiving an indication of a length of the indication of the activity statuses of the beams for the frequency resource range.

Aspect 17: The method of any of Aspects 12-16, further comprising: receiving an indication that the indication of the activity statuses is associated with the beam group type.

Aspect 18: The method of any of Aspects 12-17, further comprising: receiving an indication of an allocation of frequency resources and spatial resources for the frequency resource range, wherein the allocation of the frequency resources and spatial resources of for the frequency resource range is based at least in part on the activity statuses of the beams.

Aspect 19: The method of any of Aspects 12-18, further comprising: providing an indication that the first network node supports the configuration of the beam group type.

Aspect 20: The method of any of Aspects 12-19, wherein the configuration of the beam group type is associated with a first number of bits to indicate an allocation of frequency resources and spatial resources for the frequency resource range, wherein an additional configuration of an additional beam group type is associated with a second number of bits to indicate the allocation of frequency resources and the spatial resources for the frequency resource range, and wherein the first number of bits is less than the second number of bits based at least in part on the spatial resources being non-contiguous spatial resources.

Aspect 21: The method of any of Aspects 12-20, wherein the configuration of the beam group type is associated with using a single message to indicate an allocation of non-contiguous spatial resources for a subset of the frequency resource range.

Aspect 22: The method of any of Aspects 12-21, wherein receiving the indication of the activity statuses of the beams for the frequency resource range comprises: receiving a section extension message.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first network node for wireless communication, comprising:
a memory; and
one or more processors, coupled to the memory, configured to:
provide, to a second network node, an indication of a configuration of a beam group type that supports indications of activity statuses of beams for a frequency resource range; and
provide, to the second network node, an indication of the activity statuses of the beams for the frequency resource range, the indication of the activity statuses of the beams including an indication of a first set of beams that are active and an indication of a second set of beams that are inactive.

2. The first network node of claim 1, wherein the first network node comprises a distributed unit, and
wherein the second network node comprises a radio unit.

3. The first network node of claim 1, wherein one or more first beams of the beams are associated with a first user equipment (UE), and
wherein one or more second beams of the beams are associated with a second UE.

4. The first network node of claim 1, wherein the indication of the activity statuses comprises a bitmap, and
wherein bits of the bitmap indicate activity statuses of the beams of the frequency resource range.

5. The first network node of claim 1, wherein the one or more processors are further configured to:
provide an indication of a length of the indication of the activity statuses of the beams for the frequency resource range.

6. The first network node of claim 1, wherein the one or more processors are further configured to:
provide an indication that the indication of the activity statuses is associated with the beam group type.

7. The first network node of claim 1, wherein the one or more processors are further configured to:
provide an indication of an allocation of frequency resources and spatial resources for the frequency resource range,
wherein the allocation of the frequency resources and spatial resources of for the frequency resource range is based at least in part on the activity statuses of the beams.

8. The first network node of claim 1, wherein the one or more processors are further configured to:
receive an indication that the second network node supports the configuration of the beam group type.

9. The first network node of claim 1, wherein the configuration of the beam group type is associated with a first number of bits to indicate an allocation of frequency resources and spatial resources for the frequency resource range,
wherein an additional configuration of an additional beam group type is associated with a second number of bits to indicate the allocation of frequency resources and the spatial resources for the frequency resource range, and
wherein the first number of bits is less than the second number of bits based at least in part on the spatial resources being non-contiguous spatial resources.

10. The first network node of claim 1, wherein the configuration of the beam group type is associated with using a single message to indicate an allocation of non-contiguous spatial resources for a subset of the frequency resource range.

11. The first network node of claim 1, wherein the one or more processors, to provide the indication of the activity statuses of the beams for the frequency resource range, are configured to:
provide a section extension message.

12. A first network node for wireless communication, comprising:
a memory; and
one or more processors, coupled to the memory, configured to:
receive, from a second network node, an indication of a configuration of a beam group type that supports indications of activity statuses of beams for a frequency resource range; and
receive, from the second network node, an indication of the activity statuses of the beams for the frequency resource range, the indication of the activity statuses of the beams including an indication of a first set of beams that are active and an indication of a second set of beams that are inactive.

13. The first network node of claim 12, wherein the second network node comprises a distributed unit, and
wherein the first network node comprises a radio unit.

14. The first network node of claim 12, wherein one or more first beams of the beams are associated with a first user equipment (UE), and
wherein one or more second beams of the beams are associated with a second UE.

15. The first network node of claim 12, wherein the indication of the activity statuses comprises a bitmap, and
wherein bits of the bitmap indicate activity statuses of the beams of the frequency resource range.

16. The first network node of claim 12, wherein the one or more processors are further configured to:
receive an indication of a length of the indication of the activity statuses of the beams for the frequency resource range.

17. The first network node of claim 12, wherein the one or more processors are further configured to:
receive an indication that the indication of the activity statuses is associated with the beam group type.

18. The first network node of claim 12, wherein the one or more processors are further configured to:
receive an indication of an allocation of frequency resources and spatial resources for the frequency resource range,
wherein the allocation of the frequency resources and spatial resources of for the frequency resource range is based at least in part on the activity statuses of the beams.

19. The first network node of claim 12, wherein the one or more processors are further configured to:
provide an indication that the first network node supports the configuration of the beam group type.

20. The first network node of claim 12, wherein the configuration of the beam group type is associated with a first number of bits to indicate an allocation of frequency resources and spatial resources for the frequency resource range,
wherein an additional configuration of an additional beam group type is associated with a second number of bits to indicate the allocation of frequency resources and the spatial resources for the frequency resource range, and
wherein the first number of bits is less than the second number of bits based at least in part on the spatial resources being non-contiguous spatial resources.

21. The first network node of claim 12, wherein the configuration of the beam group type is associated with using a single message to indicate an allocation of non-contiguous spatial resources for a subset of the frequency resource range.

22. The first network node of claim 12, wherein the one or more processors, to receive the indication of the activity statuses of the beams for the frequency resource range, are configured to:
receive a section extension message.

23. A method of wireless communication performed by a first network node, comprising:
providing, to a second network node, an indication of a configuration of a beam group type that supports indications of activity statuses of beams for a frequency resource range; and
providing, to the second network node, an indication of the activity statuses of the beams for the frequency resource range, the indication of the activity statuses of the beams including an indication of a first set of beams that are active and an indication of a second set of beams that are inactive.

24. The method of claim 23, wherein the first network node comprises a distributed unit, and
wherein the second network node comprises a radio unit.

25. The method of claim 23, wherein the indication of the activity statuses comprises a bitmap, and
wherein bits of the bitmap indicate activity statuses of the beams of the frequency resource range.

26. The method of claim 23, further comprising:
providing an indication of an allocation of frequency resources and spatial resources for the frequency resource range,
wherein the allocation of the frequency resources and spatial resources of for the frequency resource range is based at least in part on the activity statuses of the beams.

27. A method of wireless communication performed by a first network node, comprising:
receiving, from a second network node, an indication of a configuration of a beam group type that supports indications of activity statuses of beams for a frequency resource range; and
receiving, from the second network node, an indication of the activity statuses of the beams for the frequency resource range, the indication of the activity statuses of the beams including an indication of a first set of beams that are active and an indication of a second set of beams that are inactive.

28. The method of claim 27, wherein the second network node comprises a distributed unit, and
wherein the first network node comprises a radio unit.

29. The method of claim 27, wherein the indication of the activity statuses comprises a bitmap, and
wherein bits of the bitmap indicate activity statuses of the beams of the frequency resource range.

30. The method of claim 27, further comprising:
receiving an indication of an allocation of frequency resources and spatial resources for the frequency resource range,
wherein the allocation of the frequency resources and spatial resources of for the frequency resource range is based at least in part on the activity statuses of the beams.
